(19) United States
(12) Patent Application Publication
(10) Pub. No.: US 2005/0215124 A1
(43) Pub. Date: Sep. 29, 2005

(54) Fuel cell voltage monitoring system and associated electrical connectors

(76) Inventors: Michael Vale, Brampton (CA); Bryn Epp, North York (CA); Stephane Masse, Toronto (CA); Nathaniel Ian Joos, Toronto (CA)

Correspondence Address: BERESKIN AND PARR, 40 KING STREET WEST, BOX 401, TORONTO, ON, M5H 3Y2, CA

(21) Appl. No.: 11/037,190

(22) Filed: Jan. 19, 2005

Related U.S. Application Data
(60) Provisional application No. 60/537,013, filed on Jan. 20, 2004.

(51) Int. Cl. H01R 24/00

(52) U.S. Cl. 439/637

(57) ABSTRACT

The invention provides a voltage monitoring system with a partially distributed electrical connector for connecting circuit components of the voltage monitoring system to one or more components associated with the plurality of electrochemical cells. The at least one partially distributed electrical connector comprises a connector for connecting with the circuit components, a unitary portion connected to the connector, a distributed portion having a first end connected to the unitary portion and a second end connected to the one or more components associated with the plurality of electrochemical cells, and, a plurality of conductors running from the connector to the second end of the distributed portion, the plurality of conductors being electrically isolated from one another. The distributed portion is flexible.

### REFERENCE TO RELATED APPLICATION

This application claims priority from U.S. Provisional Patent Application Ser. No. 60/537,013 filed Jan. 20, 2004.

### FIELD OF THE INVENTION

The invention relates to a voltage monitoring system. More particularly, this invention relates to a voltage monitoring system for electrochemical cells.

### BACKGROUND OF THE INVENTION

A fuel cell is an electrochemical device that produces an electromotive force by bringing the fuel (typically hydrogen) and an oxidant (typically air) into contact with two suitable electrodes and an electrolyte. A fuel, such as hydrogen gas, for example, is introduced at a first electrode where it reacts electrochemically in the presence of the electrolyte to produce electrons and cations in the first electrode. The electrons are circulated from the first electrode to a second electrode through an electrical circuit connected between the electrodes. Cations pass through the electrolyte to the second electrode. Simultaneously, an oxidant, such as oxygen or air is introduced to the second electrode where the oxidant reacts electrochemically in the presence of the electrolyte and a catalyst, producing anions and consuming the electrons circulated through the electrical circuit. The cations are consumed at the second electrode. The anions formed at the second electrode or cathode react with the cations to form a reaction product. The first electrode or anode may alternatively be referred to as a fuel or oxidizing electrode, and the second electrode may alternatively be referred to as an oxidant or reducing electrode. The half-cell reactions at the first and second electrodes are shown in equations 1 and 2 respectively.
H₂→2H⁺+2e⁻ (1)
1/2O₂+2H⁺+2e⁻→H₂O (2)

The external electrical circuit withdraws electrical current and thus receives electrical power from the fuel cell. The overall fuel cell reaction produces electrical energy as shown by the sum of the separate half-cell reactions shown in equations 1 and 2. Water and heat are typical by-products of the reaction.

In practice, fuel cells are not operated as single units. Rather, fuel cells are connected in series, either stacked one on top of another or placed side by side. The series of fuel cells, referred to as a fuel cell stack, is normally enclosed in a housing. The fuel and oxidant are directed through manifolds in the housing to the electrodes. The fuel cell is cooled by either the reactants or a cooling medium. The fuel cell stack also comprises current collectors, cell-to-cell seals and insulation while the required piping and instrumentation are provided external to the fuel cell stack. The fuel cell stack, housing and associated hardware constitute a fuel cell module.

Various parameters have to be monitored to ensure proper fuel cell stack operation and to prevent damage to any part of the fuel cell stack. One of these parameters is the voltage across each fuel cell in the fuel cell stack hereinafter referred to as cell voltage. During operation of a fuel cell stack, individual cell voltages may drop to an unacceptable level due to various reasons, e.g. flooding. Reversed voltage may even occur in some cells. This could lead to poor performance of the fuel cell stack, faster degradation of fuel cell stack components and consequently shorter lifespan, as well as shut down of the fuel cell system.

Ideally, differential voltage measurement is done at the two terminals (i.e. anode and cathode) of each fuel cell in the fuel cell stack. However, since fuel cells are connected in series, and typically in large number, conventional voltage monitoring systems employ a large number of sensing components, each having contacting elements and/or cables, to convey measured signals representing cell voltages to a processor for analysis. Conventionally, the processor, as well as any other instrumentation used for processing the measured signal, are usually provided at a remote physical location. However, having a large number of individual, relatively lengthy connections in a conventional fuel cell voltage monitoring system increases the chance of incorrect signal measurement since some of the connections may become loose for example. In addition, the deployment of such fuel cell voltage systems is physically complicated which can make the deployment process cumbersome, labor intensive and time-consuming. Such voltage measuring systems are also bulky, difficult to maintain, troubleshoot and are sometimes prohibitively expensive.

Furthermore, the plates used for the fuel cells in a given fuel cell stack may have different thicknesses, with respect to plates used for other fuel cells, since fuel cell plates are designed for different applications, different power requirements or for different types of fuel cells. Accordingly, it would be convenient to have a means that can be used to physically connect a fuel cell voltage monitoring system to fuel cell plates of different sizes without having to physically modify the fuel cell voltage monitoring system.

Another concern is that the thickness, length and width of each fuel cell plate within a given fuel cell stack may vary, either deliberately or due to manufacturing tolerance. In addition, during operation, thermal expansion inevitably occurs within a fuel cell stack which leads to a variation in the dimensions of the fuel cell plates. Also, during compression and decompression of the fuel cell stack, which occurs while building and rebuilding the fuel cell stack, the dimensions of the fuel cell stack and the fuel cell plates may also change. Further, during operation, a fuel cell stack may be subject to vibration.

Unfortunately, conventional fuel cell voltage monitoring systems are usually custom designed for a certain fuel cell stack and hence lack the flexibility to accommodate all of the above-mentioned variations. Conventional fuel cell voltage monitoring systems often lack the ability to provide reliable connections under such circumstances and the large number of connections makes maintenance of reliable connections extremely difficult.

U.S. Patent Application Publication No. 2002/0090540 describes an electrical contacting device that can be used to measure fuel cell voltages. The electrical contacting device is mounted on the face of a fuel cell stack and comprises a printed circuit board having a plurality of electrically conducive terminals that are in contact with plates of individual fuel cells. Accordingly, the electrical contacting device has many predefined electrically conductive regions that need to engage all of the fuel cell plates of the fuel cell stack. However, the electrical contacting device still lacks the flexibility to accommodate significant variations in fuel cell plate dimensions since the electrically conductive regions are formed on the same substrate. More rigid arrangements are disclosed in U.S. Patent Application Publication Nos. 2003/0054220 and 2003/0215678.

Accordingly, there remains a need for a compact fuel cell voltage monitoring system that is easy to use and maintain and that is flexible to accommodate variations of fuel cell stacks and fuel cell plates.

### SUMMARY OF THE INVENTION

In one aspect, at least one embodiment of the invention provides a voltage monitoring system for monitoring voltages associated with a plurality of electrochemical cells. The voltage monitoring system comprises circuit components being adapted for receiving and processing the voltages; and at least one partially distributed electrical connector for connecting the circuit components to one or more components associated with the plurality of electrochemical cells. The at least one partially distributed electrical connector includes a connector connected to the circuit components; a unitary portion connected to the connector; a distributed portion having a first end connected to the unitary portion and a second end connected to the one or more components associated with the plurality of electrochemical cells; and, a plurality of conductors running from the connector to the second end of the distributed portion, the plurality of conductors being electrically isolated from one another. The distributed portion is flexible.

The distributed portion includes a plurality of fingers each having at least one of the plurality of conductors and being separable from one another. Each finger is flexible in at least two dimensions. Each finger includes an insulated portion and an exposed portion, wherein the exposed portion is connected to a component associated with the plurality of electrochemical cells.

Each conductor may include a first section and a second section, wherein the first section has a thickness larger than the second section, and the first section extends to form the exposed portion and the second section is located within the insulated portion.

The unitary portion is flexible. Further, the unitary portion provides degrees of freedom for movement of the at least one partially distributed electrical connector that are quasi-independent from degrees of freedom for movement that are provided by the distributed portion.

The unitary and distributed portions may be formed on flexible printed circuit board material. The unitary portion may be formed from a ribbon cable.

The partially distributed connector may further include a transition region connected between the unitary portion and the distributed portion for increasing the spacing between the plurality of conductors.

The circuit components of the voltage monitoring system may be provided on a printed circuit board that is at least partially flexible, the printed circuit board being mounted adjacent to the electrochemical cells.

Portions of the circuit components are preferably laid out in a plurality of modules, wherein each module is connected to one of the at least one partially distributed electrical connectors and each module includes multiplexing and analog to digital conversion circuitry connected to the one of the at least one partially distributed electrical connector.

One of the plurality of modules is referenced to a portion of the electrochemical cells and the remaining plurality of modules area each connected to a previous module of the plurality of modules for receiving a reference voltage.

Each module may further include a bank of differential amplifiers connected between the one of the partially distributed electrical connectors and the multiplexing and analog to digital conversion circuitry.

The circuit components may include processing circuitry connected to the multiplexing and analog to digital conversion circuitry of each of the plurality of modules; a power supply connected to the multiplexing and analog to digital conversion circuitry of each of the plurality of modules; and, isolation circuitry for connecting the processing circuitry and the power supply to the multiplexing and analog to digital conversion circuitry.

In another aspect, at least one embodiment of the invention provides a partially distributed electrical connector for connecting the circuit components of a voltage monitoring system to one or more components associated with the plurality of electrochemical cells. The at least one partially distributed electrical connector comprises a connector for connecting with the circuit components, a unitary portion connected to the connector, a distributed portion having a first end connected to the unitary portion and a second end connected to the one or more components associated with the plurality of electrochemical cells, and, a plurality of conductors running from the connector to the second end of the distributed portion, the plurality of conductors being electrically isolated from one another. The distributed portion is flexible.

In another aspect, at least one embodiment of the invention provides a voltage monitoring system for monitoring voltages associated with a plurality of electrochemical cells. The voltage monitoring system comprises circuit components being adapted for receiving and processing the voltages, and, at least one partially distributed electrical connector for connecting the circuit components to a plurality of measurement points associated with the plurality of electrochemical cells. The at least one partially distributed electrical connector includes a connector connected to the circuit components; a unitary portion connected to the connector; a distributed portion having a first end connected to the unitary portion and at a plurality of second ends connected to the plurality of measurement points associated with the plurality of electrochemical cells; and, a plurality of conductors running from the connector to the second end of the distributed portion, the plurality of conductors being electrically isolated from one another. For a given partially distributed electrical connector, the unitary portion provides degrees of freedom for movement of the given partially distributed electrical connector that are quasi-independent from degrees of freedom for movement that are provided by the distributed portion.

### BRIEF DESCRIPTION OF THE DRAWINGS

For a better understanding of the invention and to show more clearly how it may be carried into effect, reference will now be made, by way of example only, to the accompanying drawings which show at least one exemplary embodiment of the invention and in which:

FIG. 1 shows a side view of an exemplary embodiment of a fuel cell voltage monitoring system, in accordance with the invention, attached to a fuel cell stack;

FIG. 2a shows a top view of an exemplary embodiment of a partially distributed electrical connector, in accordance with the invention, that can be used with the fuel cell voltage monitoring system of FIG. 1;

FIG. 2b shows a magnified side view of a portion of the partially distributed electrical connector of FIG. 2a;

FIG. 3a is a block diagram of an exemplary embodiment of a fuel cell voltage monitoring system in accordance with the invention;

FIG. 3b is a block diagram of another exemplary embodiment of a fuel cell voltage monitoring system in accordance with the invention; and,

FIG. 4 is a block diagram of an exemplary embodiment of a layout for a printed circuit board for accommodating circuitry for a fuel cell voltage monitoring system in a modular fashion in accordance with the invention.

### DETAILED DESCRIPTION OF THE INVENTION

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements. In addition, numerous specific details are set forth in order to provide a thorough understanding of the invention. However, it will be understood by those of ordinary skill in the art that the invention may be practiced without these specific details. In other instances, well-known methods, procedures and components have not been described in detail so as not to obscure the invention. The description is not to be considered as limiting the scope of the invention, but rather as merely providing a particular preferred working embodiment thereof.

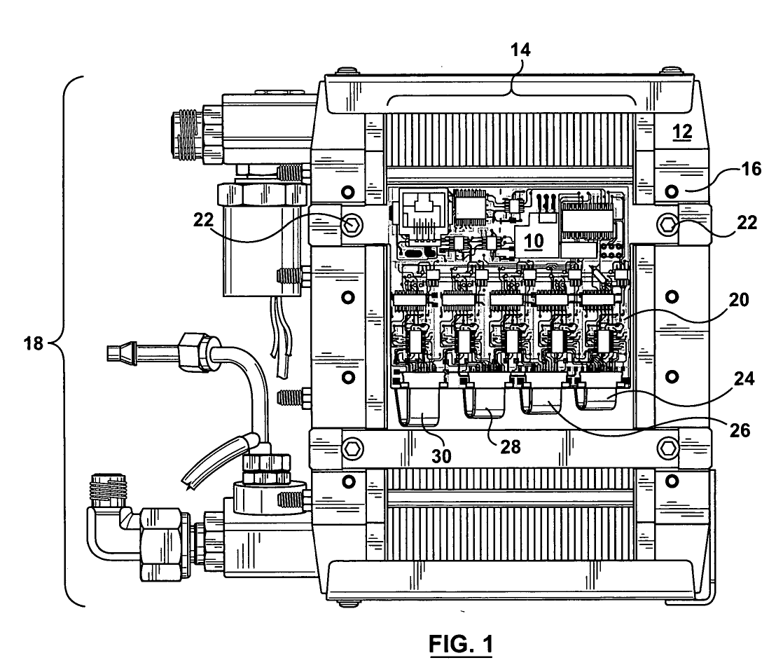

Referring now to FIG. 1, shown therein is a side view of an exemplary embodiment of a fuel cell voltage monitoring system 10, in accordance with the invention, attached to a fuel cell stack 12. The fuel cell stack 12 includes a plurality of fuel cells 14 connected in series. Any suitable fuel cell may be used. Taking a Proton Exchange Membrane (PEM) fuel cell as an example, each fuel cell 14 typically includes two flow field plates for guiding reactants, namely fuel and oxidant, to a PEM disposed there between. The fuel cell stack 12 further includes an enclosure or housing 16 as well as a number of peripheral components 18 that perform functions that are necessary for the operation of the fuel cell stack 12 such as supplying oxygen, fuel and coolant to the fuel cell stack 12, removing reaction by-products such as water, as well as providing electrical connections for harnessing electrical energy from the fuel cell stack 12.

Each fuel cell 14 typically generates a voltage of about 0.6 to 1.0 V. Fuel cell voltages are usually measured at the two flow field plates for a given fuel cell to determine if the fuel cell is operating in an acceptable fashion. However, it is understood by those skilled in the art that voltages may be sensed at any two flow field plates across a desirable number of fuel cells in the fuel cell stack 12 as well as other points along the fuel cell stack 12. The fuel cell voltage monitoring system 10 is connected to the various fuel cells 14 in the fuel cell stack 12 using a flexible connection means, in accordance with the invention, to reliably measure fuel cell voltages and provide the measured fuel cell voltages to an operator or controller of the fuel cell stack 12. In certain embodiments, the fuel cell voltage monitoring system 10 may provide status messages regarding the status of the fuel cell stack 12, and possibly warning messages if one or more of the fuel cells 14 in the fuel cell stack 12 are not operating properly.

The fuel cell voltage monitoring system 10 includes a printed circuit board (PCB) 20 that includes a number of electrical components, as shown, for measuring fuel cell voltages, directing the operation of the fuel cell voltage monitoring system 10 and communicating with external processing components as needed. For communication purposes, the fuel cell voltage monitoring system 10 includes a network port and associated electronics, as is commonly known by those skilled in the art. Conventional techniques may be utilized for attaching these electrical components to the PCB 20. Exemplary embodiments for the electrical processing components of the fuel cell voltage monitoring system 10 will be discussed in further detail below.

Preferably, the PCB 20 is provided with a mounting means 22 for removably attaching the PCB 20 to the fuel cell stack 12. The mounting means 22 may be any suitable attachment means, such as screws, fasteners, and the like. As can be seen in FIG. 1, the PCB 20 and associated flexible connection means 24, 26, 28 and 30 are disposed immediately adjacent to the fuel cell stack 12. The fuel cell voltage monitoring system 10 is preferably mounted within the housing 16. This significantly reduces the distance between the fuel cell voltage processing system 10 and the fuel cell stack 12 and hence a large number of long cables which would otherwise be needed in a conventional fuel cell voltage monitoring system are omitted. This in turn provides greater reliability for the voltage measurements that are taken by the fuel cell voltage monitoring system 10. Furthermore, a suitable network connection is employed for providing communication between the fuel cell voltage monitoring system 10 and external devices. This also results in a fewer number of external cables for the fuel cell voltage monitoring system 10. These attributes allow the fuel cell voltage monitoring system 10 to be more compact, reliable, and easy to install and maintain.

To address a number of the problems associated with connecting voltage monitoring circuitry to a fuel cell stack, the fuel cell voltage monitoring system 10 advantageously employs a partially distributed electrical connector 24. In one embodiment, as shown in FIG. 1, there may be more than one partially distributed electrical connector 24. The partially distributed electrical connector 24 includes a number of electrically conductive elements, which are insulated from one another, that are typically in contact with various fuel cell plates in the fuel cell stack 14 to facilitate voltage measurements thereat. In addition, the PCB 20 may be flexible, or at least partially flexible. This provides the fuel cell voltage monitoring system 10 with more than one degree of flexibility in the sense that the partially distributed electrical connector 24 is flexible in more than one dimension and at least some portions of the PCB 20 may be flexible and that the flexibility of these two elements are independent of one another.

The use of the partially distributed electrical connector 24 allows the fuel cell voltage monitoring system 10 to accommodate vibrations, variations in fuel cell plate thicknesses and surface areas, which may be deliberate, or due to manufacturing tolerances or other factors such as thermal expansion during use, or variations due to the building and rebuilding of the fuel cell stack 12. For instance, the flexible nature of the partially distributed electrical connector 24 allows the connector 24 to have different “connection distances”. This can be seen in FIG. 1 which shows different partially distributed electrical connectors 24, 26, 28 and 30 connected at different locations and each having a different “amount of bend” due to the fashion, and location, in which the connectors 24, 26, 28 and 30 have been connected to the fuel cell stack 12.

The partially distributed electrical connector 24 also provides a partial reduction in the number of connections between the fuel cell stack 12 and the fuel cell voltage monitoring system 10 at least from the perspective of the PCB 20 where, in this embodiment, a single connection is made between the partially distributed electrical connector 24 and the PCB 20. The number of connections are also “virtually” reduced since the electrically conductive elements in the partially distributed electrical connector 24 are grouped together at the end of the connector 24 closest to the PCB 20 while they are separated from one another at the end closer to the fuel cells 14. This is advantageous in comparison with other fuel cell voltage monitoring systems in which there are separate cable connections running the entire length from the fuel cell plates to the voltage measuring circuitry which can is cumbersome to initially setup and then to troubleshoot if any problems arise during operation. The number of connections leaving the fuel cell voltage monitoring system 10 is also reduced. This translates into less wiring for the balance of the “plant” (i.e. the devices to which the fuel cell voltage monitoring system 10 is attached), lower material and labor cost, as well as fewer connections at which a possible failure can occur.

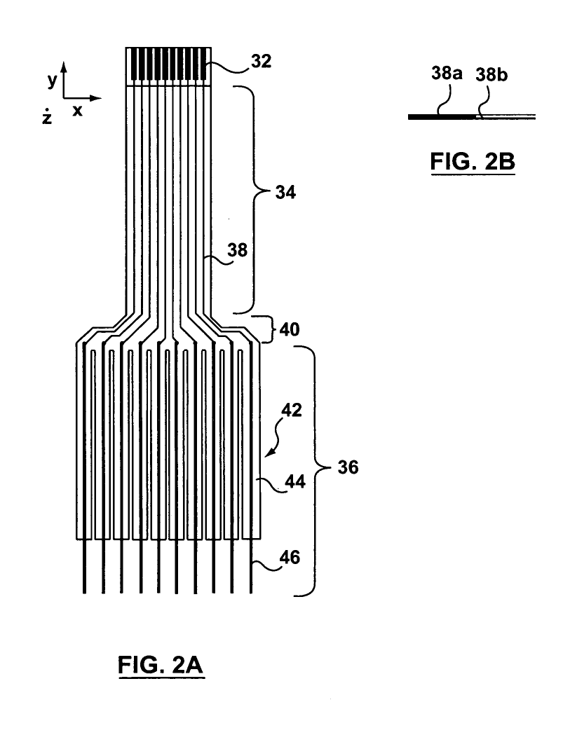

Referring now to FIG. 2a, shown therein is a top view of an exemplary embodiment of the partially distributed electrical connector 24 in accordance with the invention. The partially distributed electrical connector 24 includes a connector 32, a unitary portion 34 and a distributed portion 36. In one embodiment, the unitary portion 34 may be similar to a printed flexible circuit which includes a plurality of conductors 38 (only one of which is labeled for simplicity) that are connected to separate components of the fuel cell stack 12. The conductors 38 are enclosed in a suitable insulation material to prevent the conductors 38 from touching one another as well as to prevent the conductors 38 from corroding. Each conductor 38 then terminates at an end terminal in the connector 32. The connector 32 is connected to a corresponding input terminal on the PCB 20.

The conductors 38 then run through the unitary portion 34 to a transition region 36 in which the partially distributed electrical connector 24 tapers outward into the distributed portion 36. The distributed portion 36 includes a plurality of fingers 42 (only one of which is labeled for simplicity). Each of the fingers 42 has an insulated portion 44 and an exposed portion 46. In the insulated portion 44, the conductor 38 is attached to or encased within a suitable insulating material. This may be the same material that is used in the unitary portion 34. In the exposed portion 46, the conductor 38 is exposed so that it may electrically connected to an element of the fuel cell stack 12 at which a potential is to be measured.

The conductor 38 may include a single conductive element that runs continuously along the distributed portion 36 to the transition region 40 through the unitary portion 34 to the connector 32. This eliminates “joints” or connection points in the conductive measurement pathway from the fuel cell stack 12 to the PCB 20. This reduces the chances of failure during operation.

In one embodiment, the partially distributed electrical connector 24 is made from printed flexible circuit material. A stiffener is placed on the end of the printed flexible circuit material where the connector 32 is located to give the appropriate thickness for the connector 32 in order to give a good connection to the PCB 20. A suitable insulating material is chosen for the flexible circuit material such as polymide for example. An adhesive layer is used to so that the material adheres to copper or other conductive material that is used for the conductor 38. This adhesive is used on both sides of the conductive material. Accordingly, structurally, beginning from the top and working downwards, one exemplary embodiment of the partially distributed electrical connector 24 includes a top layer of polymide, an adhesive layer, a conductive layer, another layer of adhesive and another layer of polymide. The assembled flexible circuit may then be put through a solder coating process that deposits a small amount of solder (tin/lead mixture) onto the exposed areas of the conductors (i.e. portions 46 and the connector 32). This is done to prevent the conductor from oxidizing. There may be more or fewer conductive and insulating layers in the assembly to facilitate the design requirements.

Referring now to FIG. 2b, the conductor 38 includes a first conductive element 38a that has a larger thickness for the portions of the conductor 38 that are in contact with a fuel cell plate, and a second conductive element 38b having a smaller thickness for the conductive paths running from the insulated regions 44 of the fingers 42 to the connector 32. In practice, the first and second conductive element 38a and 38b are part of the same conductive layer (i.e. there are no joints or connections) but have been etched to different thickness. The location of where the change in thickness occurs may be varied. For instance, it may be closer to the end of a given finger 42, as shown in FIG. 2b, it can be closer to the transition region 40 as shown in FIG. 2a or it the thickness change may occur somewhere between these two points.

In one exemplary embodiment, the thinner conductive paths 38b can be etched down to a smaller size such as 0.005 inches and the thicker conductive paths 38a can have a thickness of 0.010 inches. A thicker conductive layer is used to prevent the exposed portion 46 of the finger 42 from breaking off during use. The thicker conductive layer 38a is also more rigid so that it can be bent and hold shape if needed. The thickness of the conductor 38b inside the insulation portion 44 is selected to provide the partially distributed electrical connector 24 with flexibility while maintaining a physically robust circuit path.

As shown in FIG. 2a, the fingers 42 are spaced apart from one another; the spacing is determined by the amount of tapering in the transition region 40 as well as the amount of insulation used in the insulated portion 44. Dimensions for the amount of tapering and length of the insulation portion may be chosen depending on the dimensions of the fuel cells that are used within the fuel cell stack 12 to which the partially distributed electrical connector 24 is to be connected. However, these dimensions may also be chosen so that the partially distributed electrical connector 24 can be used with several different fuel cell stacks having fuel cell plates of different dimensions. Another dimension that can be varied so that the partially distributed electrical connector 24 may be used with a variety of different fuel cell stacks is the length of the exposed portion 46.

In one exemplary embodiment, using flexible printed circuit material, the exposed portion 46 may be 6.5 mm long and 0.5 mm wide, the insulated portion of 44 may be 34 mm long and 3.4 mm wide and the finger section 36 may be 24.5 mm long. There may be a 1 mm spacing between each finger 42. The unitary section 34 may have a length of 75 mm and a width of 9 mm. Several other different sets of dimensions may be used to work with fuel cell stacks of different sizes.

Each of the fingers 42 is preferably separated from adjacent fingers 42 and moveable in three dimensions due to the flexible nature of the partially distributed electrical connector 24. For instance, movement can be made in the x and y directions in the plane of the partially distributed electrical connector 24 and in the z direction which is perpendicular to that plane. Movement in the x and y directions can be achieved by moving the conductor 38 of a finger 42 inwards and outwards in a left-right, top-down or arced motion along the plane of the partially distributed electrical connector 24 while movement in the z direction can be achieved by moving the conductor 38 in the FIG. 42 upwards and downwards with respect to the plane of the partially distributed electrical connector 24. Most of the variation in the fuel cell stack 12 is in the “left-right” axis due to plate machining tolerance, membrane thickness tolerance, gasket thickness tolerance, thermal expansion, and other factors and this is easily accommodated by the partially distributed flexible connector 24. The partially distributed electrical connector 24 also has the ability to virtually “change length” since certain regions of the connector 24 can form an arch. The finger portion 42 or the unitary portion 34 could be arched if there was a need. Portions of the partially distributed electrical connector 24 can also be folded or creased to form a right angle or other shape if needed.

The fingers 42 of the partially distributed electrical connector 24 may be attached to a fuel cell plate using an adhesive, a tape or any other suitable means. In one embodiment, a connection may be made by using a conductive epoxy resin to glue a finger down onto a fuel cell plate. This may be done by centering the exposed portion 46 of the finger 42 on the fuel cell plate to get the epoxy on both sides of the finger 42 as well as above and below the finger 42. The end of the insulated portion may also be attached to the fuel cell plate using an appropriate adhesive such as double-sided tape. This is useful for holding the finger 42 down while the epoxy cures as well as to use the epoxy as a conducting-only connection and not a mechanical connection. Alternatively, the tape could be omitted or removed after curing. Another embodiment includes using a plastic bar to put force on the connection after the epoxy cures. Several other methods can be used to attach the fingers 42 such as using conductive two-sided tape, pure mechanical force with a bar (possible vibration problem) or soldering. However, soldering requires the use of metal for the fuel cell plates or at least a metal portion on the fuel cell plates or other part of the fuel cell that can accept a solder connection (i.e. a metal insert in molded carbon plate, a metal gasket, etc.).

There may be other embodiments in which the partially distributed electrical connector 24 may not have a transition region 40 if there is enough separation between the conductors 38 to accommodate the thickness of the fuel cells plates to which the partially distributed electrical connector 24 will be attached. In these embodiments, the fingers 42 may not have to be separated from one another, it is still possible to move the fingers 42 in at least two axes: in and out (i.e. along the length of the connector 24) and up and down (i.e. perpendicular to the plane of the connector 24), as well as some limited bending side-to-side. This embodiment may be suitable for fuel cell stacks with a fewer number of fuel cells or with fuel cell stacks that have fuel cell plates that are quite thin, as is known by those skilled in the art. Metal flow field plates are also an example in which a transition region may not be needed since the width of the partially distributed electrical connector at the “fingers” end may be the same width as the connector section 32. Such an embodiment may also be useful in cases in which there is a large production of a fixed fuel cell stack size in which one partially distributed electrical connector can be used to cover the complete fuel cell stack. This results in the voltage monitoring system being a one-piece assembly that can be bolted onto the fuel cell stack at one side of the assembly. This eliminates the number of partially distributed electrical connectors connected to the PCB 20 which improves reliability and lowers cost.

When the fingers 42 are being attached to fuel cell plates, the ability to move the fingers 42 in at least two dimensions allows the fingers 42 to accommodate fuel cell plate displacements along the longitudinal direction of the fuel cell stack 12, i.e. in the direction parallel to the plane of the PCB 20 as well as accommodate length variations of the fuel cell plates in the direction perpendicular to the plane of the partially distributed electrical connector 24. Preferably, greater flexibility is obtained by engaging only one finger 42 to one fuel cell flow field plate. However, there may be some instances in which it is preferable to connect more than one finger 42 to a fuel cell plate or other measurement point. For instance, for conducting voltage distribution measurements on a fuel cell plate, one requires two or more fingers 42 on the same fuel cell plate; the fingers 42 are placed at different locations on the fuel cell plate. In addition, more than one finger 42 may be attached to a fuel cell plate to provide the fuel cell voltage monitoring system 10 with redundancy.

It should further be understood that the partially distributed electrical connector 24 has portions that provide degrees of freedom in terms of movement that are relatively independent with respect to one another. For instance, the unitary portion 34 may bend in some directions while, at the same time, the fingers 42 in the distributed portion 36 may bend in other directions. These separate degrees of freedom for movement allow the partially distributed electrical connector 24 to more easily accommodate vibrations, uneven plate thicknesses and sizes and the like.

It should also be noted that providing several partially distributed electrical connectors 24, 26, 28 and 30 is also advantageous since each partially distributed electrical connectors 24, 26, 28 and 30 is physically separate from one another. This further increases the flexibility of the connection means for the fuel cell voltage monitoring system 10 in comparison to conventional fuel cell voltage monitoring systems that have a single unitary long connector that is attached to a fuel cell stack. In particular, by providing several separate electrical connectors 24, 26, 28 and 30, vibrations are somewhat independently experienced by each of the electrical connectors 24, 26, 28 and 30. Further, the use of several separate electrical connectors 24, 26, 28 and 30 allows for a more modular design of the circuitry on the PCB 20 of the fuel cell voltage monitoring system 10. This modular design allows the fuel cell voltage monitoring system 10 to be easily scaleable for monitoring fuel cells of varying sizes. The modular design also results in a smaller number of parts that are required to construct the fuel cell voltage monitoring system 10 and therefore a fewer number of parts are needed in inventory.

In another alternative embodiment, depending on the size of the fuel cell stack and its components, it may be advantageous to make the partially distributed electrical connector 24 from a ribbon cable. In this case, the conductor 38 may include several separate conductive elements that are connected at one or more locations within the partially distributed electrical connector 24 by a suitable connection such as a solder connection. For instance, one conductive element may run the length of the distribution portion 36 and connect to a second conductive element that runs the length of the transition region 40. The second conductive element may then be connected to a third conductive element that runs the length of the unitary portion 34. This embodiment with multiple conductive elements may be more advantageous in reducing tension or stress that is experienced by the conductor 38 for certain embodiments of the fuel cell stack 12 and the voltage monitoring system 10.

In another embodiment, the conductor 38 in the finger 42 may include two pieces that are joined near the junction between the insulation portion 44 and the exposed portion 46. Referring once again to FIG. 2b, the conductor 38 may include a first conductive member 38a forming the exposed portion 46 and a second conductive member 38b that is within the insulated portion 44. The first and second conductive members 38a and 38b overlap by a suitable amount so that the first conductive member 38a does not easily detach from the finger 42. It is advantageous to have a conductor 38 with more than one conductive member in the end portions of the fingers 42 since this reduces the strain in the conductor 38 when the partially distributed electrical connector 24 is attached to a fuel cell stack 12.

A voltage processing system, typically including distributed components and processing circuitry, which may include a processor for example, is provided on the PCB 20. Hence, electrical signals, typically representing cell voltages, are sensed by the fingers 42 of the partially distributed electrical connector 24, 26, 28 and 30 transmitted to the voltage processing system for digitization, pre-processing and analysis. Any suitable implementation for the voltage processing system may be used as is commonly known by those skilled in the art. One example of a voltage processing system is described in further detail below.

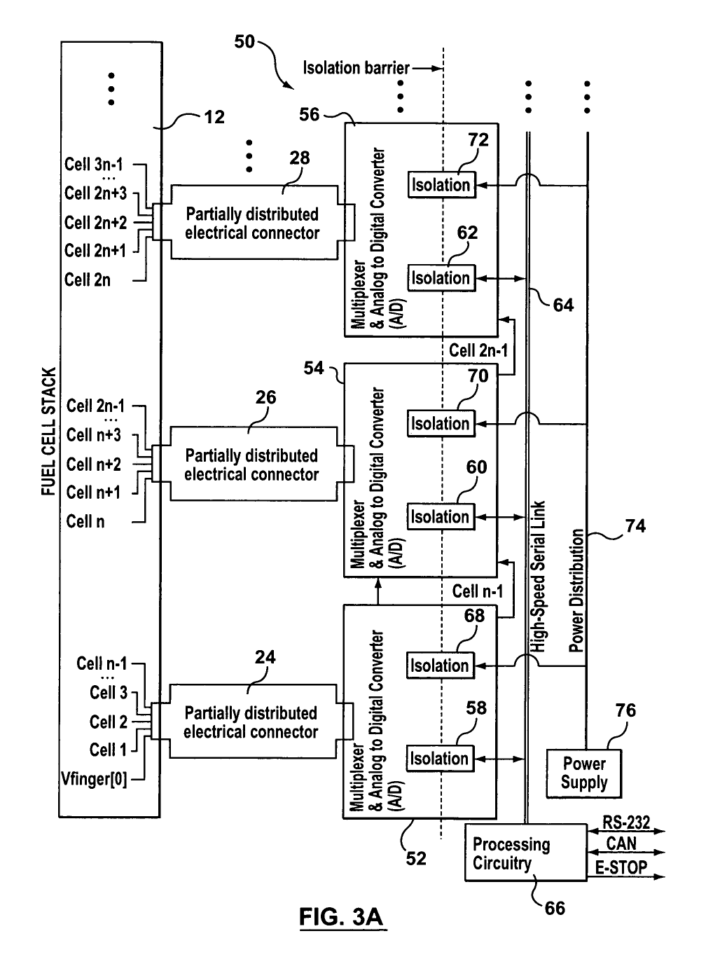

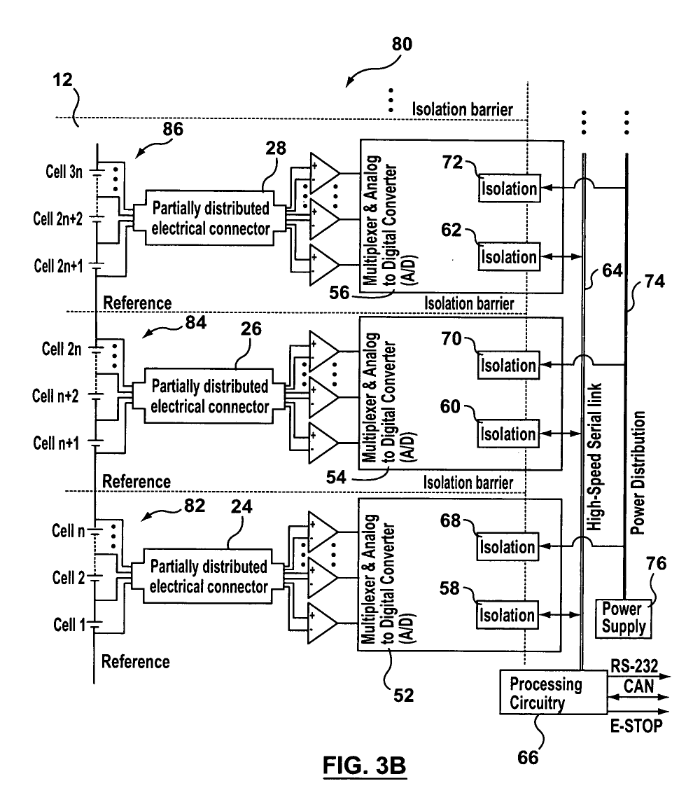

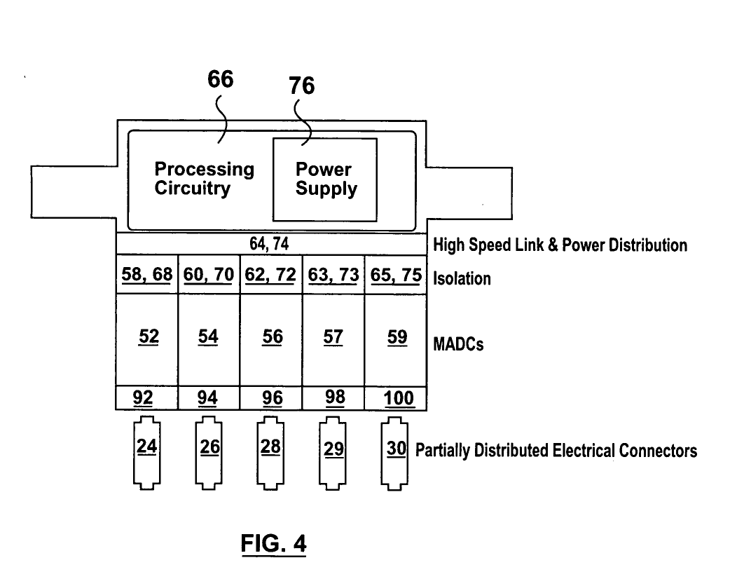

Referring now to FIG. 3a, shown therein is a block diagram of an exemplary embodiment of a fuel cell voltage monitoring system 50. Individual cell voltages are measured by means of several partially distributed electrical connectors 24, 26 and 28, as previously described, with all connectors 24, 26, and 28) providing n fingers but with connector 24 measuring n-1 cells and the remainder of the connectors 26 and 28 providing n fingers connected to n cells. For example, connectors 24, 26, and 28 may have 5 fingers, and for a 14-cell fuel cell stack, connector 24 could measure cells 1 to 4, connector 26 could measure cells 5 to 9 and connector 28 could measures cells 10 to 14. For the first cell, i.e. cell 1, there is one finger 42 connected to a cathode plate and another finger 42 connected to an anode plate. For the remainder of the cells, there is only one finger 42 per cell. In this embodiment, the voltage digitization circuitry passes the voltage at the positive connection of the last cell in a cell group to the next higher block of voltage digitization circuitry as a reference to remove the need for connecting 2 fingers to one cell at the changeover in the blocks of digitization circuitry. This arrangement also reduces the number of connections in the system since only one finger 42 is attached to each cell. The blocks of digitization circuitry 52, 54, and 56 may include a multiplexer and an analog to digital converter. Accordingly, the blocks of digitization circuitry 52, 54, and 56 may be implemented as an integrated Multiplexer and Analog to Digital converter (MADC) for example. Each MADC may include a 12-bit ADC. Alternatively, an ADC with more bits may be used to obtain more accurate digital values. The MADCs 52, 54, and 56 are connected, via appropriate isolation circuitry 58, 60 and 62, to a high-speed serial bus 64 that is connected to processing circuitry 66. Isolation circuitry 68, 70 and 72 may also be provided for connecting each MADC 52, 54, and 56 to a power distribution bus 72 that is connected to a power supply 74. Although three groups of partially distributed electrical connectors 24, 26 and 28, and MADCs 52, 54 and 56 are shown, the fuel cell voltage monitoring system 10 may be extended to accommodate any size of fuel cell stack and may therefore include a larger or smaller number of these blocks of components. Accordingly, the fuel cell voltage monitoring system of the invention is easily scaleable to accommodate fuel cell stacks of varying sizes. An example of this is modularity and scalability is shown in FIG. 4.

The isolation circuitry allows the fuel cell voltage monitoring system 50 to handle high common mode voltages. The circuit gives each MADC 52, 54 and 56 its own ground reference which is tied to the positive connection of the last cell of the corresponding block of fuel cells. The isolation circuitry (58, 68), (60, 70) and (62, 72) may each include a galvanic isolator (of any type) and an isolated power converter which can be DC-DC or AC-DC depending on the type of power supply 76 connected to the power distribution bus 74. Isolation allows for the use of low common-mode parts, which are cheaper and more available, in this normally high common-mode environment. However, in this embodiment, there may be a limit to the allowable common-mode voltage due to the maximum input voltage of the MADC. Depending on the hardware used, this may limit the number of fuel cells that can be monitored per group or block. Another limitation may be the number of input channels. For example, some MADCs have a maximum input range of 10V and 8 input channels.

The processing circuitry 66 includes circuit components for pre-processing the measured voltages, as well as circuitry for processing and monitoring the pre-processed measured voltages such as a digital signal processor or a controller. Since the fuel cell voltage monitoring system 50 is likely designed for use in a fuel cell power plant, some data analysis may be performed in real-time by the processing circuitry 66 to ensure proper operation of the fuel cell stack 12. One example of data analysis that is done in real time is to detect any fuel cells that exhibit a low operating voltage and to inform an operator, controller or control system associated with the fuel cell voltage monitoring system 50 of the cell voltages using an appropriate external communication means. Accordingly, the processing circuitry 66 may also include communication ports, such as an RS-232 port, or a CAN port, for example. With this communication circuitry, all individual cell voltages can be sent to an external device for data logging or diagnostic purposes. The communication channel may also be used for calibration, and parameter adjustment of the fuel cell voltage monitoring system 50. A hard-wire alarm line may also be used to communicate with external devices. For instance, upon an alarm condition, which could be generated for example by a low operating cell voltage, the processing circuitry 66 can activate the alarm line to shut down the entire fuel cell balance of the plant or take some other appropriate action.

Since the common-mode voltage of a fuel cell stack can reach levels that can potentially damage most electronic circuits, another isolation scheme, in addition to isolation circuitry 58, 60, 62, 68, 70 and 72, may be used that prevents the common-mode voltage from exceeding an acceptable voltage. In the embodiment shown in FIG. 3a, MADCs 54 and 56 are referenced to the preceding MADC 52 and 54 respectively. Accordingly, the isolation circuitry that is used to electrically isolate all processing circuits from one another does not isolate an adjacent neighbor in the case of MADCs 54 and 56. Also, in this isolation scheme, the ground of any one MADC is not the same as the ground for any other MADC or the ground of the power supply 76. The common mode is not excessive as the grouping of the cells into smaller blocks (in this case three smaller blocks) is such that the allowable common-mode is not exceeded for any of the blocks of fuel cells.

In the embodiment of FIG. 3a, the first MADC 52 measures individual cell voltages for fuel cell 1 by subtracting a reference voltage from the voltage measured at the top plate of the first fuel cell (i.e. eqn. 3). The voltage for the second fuel cell is measured by taking the voltage of the second finger and subtracting the voltage of the first finger (i.e. eqn 4). The remaining cells in the block are measured by the same method as for fuel cell 2. With regards to the partially distributed electrical connector 24, Vfinger[0] is the reference voltage that is used for all measurements in the MADC 52. In the second block measurement 54, the measurement technique is similar to measurement block 52 except that there is no finger on the partially distributed electrical connector 26 that provides a reference voltage. The reference voltage is provided by a link from the MADC 52 to the ground input of the MADC 54. The voltage of the topmost finger for measurement block 52 will be of at a certain voltage when measured by the MADC 52 but will be effectively be 0V with respect to the MADC 54. Voltages for cell n+1 can then be calculated according to equation 6.
Vcell[1]=Vfinger[cell 1]−Vfinger[0] (3)
Vcell[2]=Vfinger[cell 2]−Vfinger[cell 1] (4)
Vcell[n]=Vfinger[cell n]−Vfinger[cell n−1] (5)
Vcell[n+1]=Vfinger[cell n+1]−Vfinger[cell n] (6)

Therefore, only the first measurement block 52 uses a finger of the partially distributed electrical connector 24 for providing a reference voltage. All of the other voltage measurement blocks 54 and 56 have one wire/finger for the positive voltage measurement and the reference voltage measurement is provided by the last fuel cell in the preceding voltage measurement block. Accordingly, in this exemplary embodiment shown in FIG. 3a, the first MADC 52 measures the voltages across nine fuel cells and the remaining MADCs 54 and 56 measure the voltage across 10 fuel cells while receiving a reference voltage from the preceding MADC 52 and 54 respectively.

The subtraction of the voltages may also be done before digitization, via a suitable analog means, so that the measured voltages take up more of the dynamic range of the digitizers used in the MADCs 56 and 58. The advantage with this is that gain can be used when conducting a differential measurement external to the MADC blocks 52, 54 and 56. The gain allows for better use of the input range of the digitizers in the MADC blocks 52, 54 and 56 and eliminates any error that may be incurred when software subtraction is used.

Referring now to FIG. 3b, shown therein is a block diagram of another exemplary embodiment of a fuel cell voltage monitoring system 80. The fuel cell voltage monitoring system 80 is similar to the fuel cell voltage monitoring system 50 except for the placement of banks of differential amplifiers 82, 84 and 86 between the partially distributed electrical connectors 24, 26 and 28 and the MADCs 52, 54 and 56. Differential amplifiers may be used that can handle high common-mode voltages if a large voltage span between fingers (multiple cells) is desired. Regular instrumentation amplifiers may be used if the desired finger to finger voltage is an acceptable value. The isolation provided by isolation circuitry 58, 68, 60, 70, 62 and 72 still remains in place thus limiting the common mode effect to the span of the group of cells being monitored by a particular MADC (i.e. a particular measurement block). Each differential amplifier preferably is also highly linear. Each differential amplifier may have a gain of substantially unity although higher gain can also be used to take advantage of the full range of the MADC. However, the input differential is limited by the power supply voltage and the MADC input voltage as is commonly known in the art. The Burr-Brown INA 117 differential amplifier or the Analog Devices AD629 differential amplifier may be used in the differential amplifier banks 82, 84 and 86. These differential amplifiers can function with a common-mode voltage of up to 200 V and can therefore be connected directly to the cathode or anode of a fuel cell from the fuel cell stack 12.

In addition, in this embodiment, the reference voltage for a given MADC 52, 54 and 56 may be taken directly from the appropriate fuel cell plate in the fuel cell stack 12 as shown in FIG. 3b. In this case, there may be one finger that is connected to each fuel cell in the fuel cell stack 12 except for when there is a transition from one measurement block to the next. Alternatively, the reference voltage may be obtained directly from a preceding measurement block, as is done in the embodiment shown in FIG. 3a, in which case there will only be one finger per fuel cell except for the very first fuel cell in the first measurement block. The differential amplifiers 82, 84 and 86 aid in removing the small common mode voltage from each MADC block 52, 54 and 56 that is present in the fuel cell voltage monitoring system 50 shown in FIG. 3a as well as eliminating the use of software subtraction after digitization. This embodiment results in more accurate voltage measurement since the measured voltages can first be amplified and then digitized while using the reference voltage to reduce the magnitude of the voltages that are input to the digitizers in the MADCs 52, 54 and 56. The remainder of the fuel cell voltage monitoring system 80 functions as described above for fuel cell voltage monitoring system 50.

In both embodiments, a portion of the processing circuitry 66, or an external controller controls the function of the fuel cell voltage monitoring system to selectively receive sensed voltages at certain locations in the fuel cell stack 12. Sensed voltages may be measured across each fuel cell in the fuel cell stack 12 in a sequential order. Alternatively, the measured voltage across any fuel cell can be accessed at any time. Also certain calculatable values like mean cell voltage, voltage range, max voltage, min voltage, and standard deviation can be calculated and transmitted on a continuous basis or on request. The individual cell voltages may also be transmitted on a continuous basis.

In both embodiments, the processing circuitry 66 may also include a calculation means 27, which may be implemented via hardware or software, that applies a factor to the sensed voltages for more accurately monitoring the measured cell voltages. The cell voltages allow a user to assess the overall condition of an individual fuel cell. The cell voltages can be used to determine if there is water accumulation in a cell, or if gases are mixing, etc. The frequency of cell voltage measurement can also be specified. Cell voltage measurement must be sufficiently fast to report brief, transient conditions on the cells. It is preferred to perform a measurement every 10 ms on every cell, which has been shown to be more than sufficient.

In practice, the fuel cell voltage monitoring system requires calibration in order to obtain accurate voltage measurements. As is well known to those skilled in the art, when the number of individual fuel cells in a “measurement block” of fuel cells in the fuel cell stack 12 increases, the common-mode voltage of the inputs of the differential amplifier connected to fuel cells further away from the reference voltage also increases. The common-mode voltage of the inputs to the differential amplifier results in a voltage at the output of the differential amplifier which will corrupt the voltage measurement of the differential amplifier. This common-mode voltage error is equal to the product of the common-mode voltage gain of the differential amplifier and the common-mode voltage of the inputs. Thus, the common-mode voltage error is proportional to the common-mode voltage of the inputs of the differential amplifier. Accordingly, the differential amplifier preferably has a high common-mode rejection ratio (CMRR). Typically, values for CMRR are approximately in the range of 70 to 110 dB. An amplifier with a high common-mode rejection ratio, by definition, has a small common-mode voltage gain.

In addition, due to unavoidable internal mismatches in the differential amplifier, an extraneous voltage occurs at the output of the differential amplifier. This output voltage is referred to as the DC offset of the differential amplifier. The DC offset is observed as a finite voltage at the output of the differential amplifier when the inputs of the differential amplifier are connected to ground.

Furthermore, a voltage error can result in the measurement due to the quantization noise of the digitizers in the MADC 52, 54 and 56. However, as is well known in the art, the quantization noise can be reduced to an acceptable level by increasing the number of quantization bits in the ADC 24.

Due to the common-mode voltage error, the DC offset and to some extent quantization noise, the output of the differential amplifier will deviate from the actual cell voltage of the fuel cell. This deviation is referred to as a residual voltage which is a measurement error that cannot be eliminated with common differential amplifier arrangements. As discussed previously, the residual voltage is proportional to the common-mode voltage of the inputs of the differential amplifier. This is not desirable since, as the total number of individual fuel cells within a measurement block increase, the common-mode voltage of the inputs of the differential amplifier increase. Therefore, the deviation in the measured cell voltage for those fuel cells that are the furthest away from the reference voltage may be large enough to affect the accuracy of the cell voltage measurement.

This problem can be overcome if the measured cell voltage of the fuel cell is calculated based on a linear equation which uses the digital values obtained from the voltage measurement of differential amplifier. In order to perform the calculation, at least one voltmeter and at least one calibrator are needed for reading voltage values during a calibration process. Preferably, the voltmeter is a high precision voltmeter.

The cell voltage for each fuel cell, measured by a given differential amplifier, can be calculated using the following equation:

$${V}_{R} = \frac{{V}_{A} \cdot {V}_{ADC}}{[ {V}_{ADC} ( {V}_{A} ) - {V}_{ADC} ( {V}_{0} ) ]} - {V}_{OFF} \qquad ( 7 )$$

where the voltage V_{R} is the calibrated measured cell voltage, the voltage V_{ADC} is the output value of an MADC during voltage measurement, and the voltage V_{A} is the voltage applied differentially to the input of the differential amplifier during calibration, The voltage V_{A} includes two components: a calibrated differential voltage which is the difference of the voltages presented across the positive and negative input pins of the differential amplifier and a common-mode voltage which is the sum of the voltages presented across the positive and negative input pins of the differential amplifier divided by two. The voltage V_{ADC}(V_{A}) is the output value of the MADC when V_{A} is applied to the inputs of the differential amplifier during calibration, the voltage V_{ADC}(V_{O}) is the output value of the MADC when a zero volt differential voltage is presented to the positive and negative input pins of the differential amplifier and the same common-mode voltage for V_{A} is presented to the positive and negative input pins of the of the differential amplifier and the voltage V_{OFF} is the voltage output of the differential amplifier when the inputs of the differential amplifier are tied together to a common-mode voltage, such as that used for V_{A}, during calibration. The voltage V_{OFF} is measured without being digitized and accordingly may be measured by a voltmeter.

Although it is difficult to know the actual cell voltage of each fuel cell to use during calibration, it is known that individual fuel cells operate between approximately 0.5 V to 1.0 V during normal operation. By applying a calibrator that provides voltage levels close to these cell voltages, the differential amplifiers may be calibrated before they are used to measure the cell voltages of fuel cells in the fuel cell stack 12. Therefore, the common-mode voltage error and the DC offset of each differential amplifier can be obtained. Consequently, by calibrating each differential amplifier, the accuracy of the fuel cell voltage monitoring system can be increased.

Since individual fuel cells operate in the range of 0.5 V to 1.0 V, each fuel cell may be assumed to have a cell voltage of 0.75 V. This is an average voltage at which fuel cells operate during normal use. Therefore, during calibration an increment of 0.75 V is used which means the calibrator provides voltages as if the upper terminal of fuel cell 1 is at 0.75 V, the upper terminal of fuel cell 2 is at 1.5 V, the upper terminal of fuel cell 3 is at 2.25 V and so on and so forth. The inventors have found that by using this method in practice, each differential amplifier can be calibrated at a common-mode voltage which is close to the actual common-mode voltage at the cell terminals of each fuel cell when each fuel cell was operating under ideal conditions. As a result, the inventors found that the measured cell voltages were close to the actual cell voltage of each fuel cell.

Although the calibration method does not completely eliminate the residual error, it significantly reduces the residual error and most notably the common-mode voltage error. Further, after calibration, the common-mode voltage error occurring during the voltage measurement of a given differential amplifier is no longer proportional to the common-mode voltage at the inputs of the differential amplifier. The common-mode voltage error is now proportional to the difference between the actual common-mode voltage at the inputs and the assumed common-mode voltage that was used for each differential amplifier during calibration. This difference is random and does not increase as the number of fuel cells a given block of fuel cells in the fuel cell stack 12 increase. Therefore, the common-mode voltage error is maintained at a very low level during cell voltage measurement. This is particularly advantageous when measuring the cell voltage of fuel cells in a large fuel cell stack.

Referring now FIG. 4, shown therein is a schematic view of an exemplary embodiment of the layout of a flexible printed circuit board 90 for providing a modular design for the circuitry used in a fuel cell voltage monitoring system in accordance with the invention. The layout clearly shows the modular nature of the fuel cell voltage monitoring system with regions 92, 94, 96, 98 and 100 being used for connection to the partially distributed electrical connectors 24, 26, 28, 29 and 30. The layout also includes regions for MADCs 52, 54, 56, 57 and 59, or similar multiplexing and digitization circuitry. The layout then includes regions for the isolation circuitry (58,68), (60, 70), (62, 72), (63, 73) and (65, 75). Next there is a region for the high speed data link 64 and the power distribution bus 74. At the top of the layout, there is a region for the processing circuitry 66 and the power supply 76. In this fashion, a larger PCB 20 may be used to accommodate more connectors, MADCs and isolation circuitry, if they are needed, to interface with a larger fuel cell stack.

The fuel cell voltage monitoring system 10 of the invention may be used to monitor cell voltages of a complete fuel cell stack. However, the fuel cell voltage monitoring system 10 may also be used to monitor a group or several groups of fuel cells within a given fuel cell stack and several of such fuel cell voltage monitoring systems can be used for a complete fuel cell stack. In this case, the fuel cell voltage monitoring system may include several modules that are mounted on separate PCBs, and work independently of one another or may be controlled by a single controller which can be on a main PCB that each of the separate PCBs are electrically connected to. This provides the fuel cell voltage monitoring system 10 with scalability in accordance to the size of the fuel cell stack whose cell voltages are to be monitored. The use of several partially distributed electrical connectors further facilitates this modular design.

For example, there are some parts of larger fuel cell stacks that are more likely to have a larger cell voltage drop (i.e. the end cells), so one could take three fuel cell voltage monitor systems and separately monitor three different portions of the fuel cell stack, i.e. the 10 lowest fuel cells, the 10 fuel cells in the middle and the 10 highest fuel cells (or some other arrangement). The three fuel cell voltage monitoring systems may work independent of one another (i.e. three full systems with a controller each) with three separate alarm lines and three separate communication channels, or the three fuel cell voltage monitoring systems may communicate with a fourth controller that provides one alarm line and one communication interface to the fuel cell stack. A third possibility is a fuel cell voltage monitoring system with three MADC blocks and only one processor. A particular embodiment can be chosen depending on the needs of the user of the fuel cell stack.

It should be appreciated that although the invention has been described for a PEM fuel cell stack, the invention is not intended only for measuring the voltages of individual fuel cells in a fuel cell stack, but also for measuring the voltages in any kind of fuel cell, electrochemical cell or multi-cell battery formed by connecting individual cells in series. Thus, the invention could be applied to fuel cells with alkali electrolytes, fuel cells with phosphoric acid electrolyte, high temperature fuel cells (i.e. fuel cells with a membrane similar to a proton exchange membrane but adapted to operate at around 200° C.), electrolyzers, regenerative fuel cells, battery banks, capacitor banks and the like. The invention can also be applied to electrochemical cell assemblies that use gaskets or a seal-in place process to provide sealing. The invention can also be applied to electrochemical cells that use bipolar flow field plates that provide both an anode and a cathode.

It should also be understood by those skilled in the art, that various modifications can be made to the embodiments described and illustrated herein, without departing from the invention, the scope of which is defined in the appended claims.

1. A voltage monitoring system for monitoring voltages associated with a plurality of electrochemical cells, wherein the voltage monitoring system comprises:
a) circuit components being adapted for receiving and processing the voltages; and,
b) at least one partially distributed electrical connector for connecting the circuit components to one or more components associated with the plurality of electrochemical cells, wherein the at least one partially distributed electrical connector includes:
i) a connector connected to the circuit components;
ii) a unitary portion connected to the connector;
iii) a distributed portion having a first end connected to the unitary portion and a second end connected to the one or more components associated with the plurality of electrochemical cells; and,
iv) a plurality of conductors running from the connector to the second end of the distributed portion, the plurality of conductors being electrically isolated from one another,
wherein the distributed portion is flexible.

2. The voltage monitoring system of claim 1, wherein the distributed portion includes a plurality of fingers each having at least one of the plurality of conductors and being separable from one another.

3. The voltage monitoring system of claim 2, wherein each finger is flexible in at least two dimensions.

4. The voltage monitoring system of claim 2, wherein each finger includes an insulated portion and an exposed portion, wherein the exposed portion is connected to a component associated with the plurality of electrochemical cells.

5. The voltage monitoring system of claim 4, wherein each conductor includes a first section and a second section, wherein the first section has a thickness larger than the second section, and the first section extends to form the exposed portion and the second section is located within the insulated portion.

6. The voltage monitoring system of claim 1, wherein the unitary portion is flexible.

7. The voltage monitoring system of claim 6, wherein the unitary portion provides degrees of freedom for movement of the at least one partially distributed electrical connector that are quasi-independent from degrees of freedom for movement that are provided by the distributed portion.

8. The voltage monitoring system of claim 1, wherein the unitary and distributed portions are formed on flexible printed circuit board material.

9. The voltage monitoring system of claim 1, wherein the unitary portion is formed from a ribbon cable.

10. The voltage monitoring system of claim 1, wherein the at least one partially distributed connector further includes a transition region connected between the unitary portion and the distributed portion for increasing the spacing between the plurality of conductors.

11. The voltage monitoring system of claim 1, wherein the circuit components are provided on a printed circuit board that is at least partially flexible, the printed circuit board being mounted adjacent to the electrochemical cells.

12. The voltage monitoring system of claim 1, wherein portions of the circuit components are laid out in a plurality of modules, wherein each module is connected to one of the at least one partially distributed electrical connectors and each module includes multiplexing and analog to digital conversion circuitry connected to the one of the at least one partially distributed electrical connector.

13. The voltage monitoring system of claim 12, wherein one of the plurality of modules is referenced to a portion of the electrochemical cells and the remaining plurality of modules area each connected to a previous module of the plurality of modules for receiving a reference voltage.

14. The voltage monitoring system of claim 12, wherein each module further includes a bank of differential amplifiers connected between the one of the partially distributed electrical connectors and the multiplexing and analog to digital conversion circuitry.

15. The voltage monitoring system of claim 12, wherein the circuit components further include:
a) processing circuitry connected to the multiplexing and analog to digital conversion circuitry of each of the plurality of modules;
b) a power supply connected to the multiplexing and analog to digital conversion circuitry of each of the plurality of modules; and,
c) isolation circuitry for connecting the processing circuitry and the power supply to the multiplexing and analog to digital conversion circuitry.

16. The voltage monitoring system of claim 14, wherein the circuit components further include:
a) processing circuitry connected to the multiplexing and analog to digital conversion circuitry of each of the plurality of modules;
b) a power supply connected to the multiplexing and analog to digital conversion circuitry of each of the plurality of modules; and,
c) isolation circuitry for connecting the processing circuitry and the power supply to the multiplexing and analog to digital conversion circuitry.

17. A partially distributed electrical connector for connecting the circuit components of a voltage monitoring system to one or more components associated with the plurality of electrochemical cells, wherein the at least one partially distributed electrical connector comprises:
a) a connector for connecting with the circuit components;
b) a unitary portion connected to the connector;
c) a distributed portion having a first end connected to the unitary portion and a second end connected to the one or more components associated with the plurality of electrochemical cells; and,
d) a plurality of conductors running from the connector to the second end of the distributed portion, the plurality of conductors being electrically isolated from one another,
wherein the distributed portion is flexible.

18. The partially distributed electrical connector of claim 17, wherein the distributed portion includes a plurality of fingers each having at least one of the plurality of conductors and being separable from one another.

19. The partially distributed electrical connector of claim 18, wherein each finger is flexible in at least two dimensions.

20. The partially distributed electrical connector of claim 18, wherein each finger includes an insulated portion and an exposed portion, wherein the exposed portion is connected to a component associated with the plurality of electrochemical cells.

21. The partially distributed electrical connector of claim 20, wherein each conductor includes a first portion and a second portion, wherein the first portion has a thickness larger than the second portion, and the first portion extends to form the exposed portion and the second portion is located within the insulated portion.

22. The partially distributed electrical connector of claim 17, wherein the unitary portion is flexible.

23. The partially distributed electrical connector of claim 22, wherein the unitary portion provides degrees of freedom for movement of the at least one partially distributed electrical connector that are quasi-independent from degrees of freedom for movement that are provided by the distributed portion.

24. The partially distributed electrical connector of claim 17, wherein the unitary and distributed portions are formed on flexible printed circuit board material.

25. The partially distributed electrical connector of claim 17, wherein the unitary portion is formed from a ribbon cable.

26. The partially distributed electrical connector of claim 17, wherein the at least one partially distributed connector further includes a transition region connected between the unitary portion and the distributed portion for increasing the spacing between the plurality of conductors.

27. A voltage monitoring system for monitoring voltages associated with a plurality of electrochemical cells, wherein the voltage monitoring system comprises:
a) circuit components being adapted for receiving and processing the voltages; and,
b) at least one partially distributed electrical connector for connecting the circuit components to a plurality of measurement points associated with the plurality of electrochemical cells, wherein the at least one partially distributed electrical connector includes:
i) a connector connected to the circuit components;
ii) a unitary portion connected to the connector;
iii) a distributed portion having a first end connected to the unitary portion and a plurality of second ends connected to the plurality of measurement points associated with the plurality of electrochemical cells; and,
iv) a plurality of conductors running from the connector to the second end of the distributed portion, the plurality of conductors being electrically isolated from one another,
wherein for a given partially distributed electrical connector, the unitary portion provides degrees of freedom for movement of the given partially distributed electrical connector that are quasi-independent from degrees of freedom for movement that are provided by the distributed portion.
